(19) United States
(12) Patent Application Publication
(10) Pub. No.: US 2013/0220960 A1
(43) Pub. Date: Aug. 29, 2013

(54) Heave Compensated Crane

(71) Applicant: Øyvind Bjørshol, Averoy (NO)

(72) Inventor: Øyvind Bjørshol, Averoy (NO)

(21) Appl. No.: 13/825,135

(22) PCT Filed: Sep. 20, 2011
(86) PCT No.: PCT/NO11/00261

§ 371 Date: May 14, 2013

(30) Foreign Application Priority Data
Sep. 21, 2010 (NO) 20101312

(51) Int. Cl. B66C 23/53

(52) U.S. Cl. CPC B66C 23/53
USPC 212/308

(57) ABSTRACT

A heave compensated crane is described, comprising a lower vertical beam (10) and an upper horizontal beam (12) which are mutually connected via an articulated piece (20), as the vertical beam is connected at the bottom to a base (14) which in turn comprises a slew ring for rotation of the crane about a vertical axis, and a strut (22) is arranged between the base (14) and the articulated piece (20) at a distance from the vertical beam (10) and largely in parallel with this in a normal position for the crane, and that the vertical beam (10) is driven by, at least, one cylinder (18) and the upper crane beam (12) in its movement in relation to the lower beam (10) is driven by an intermediate cylinder arrangement (16), where the cylinder arrangement (16) comprises, at least, one single working cylinder (30) and, at least, one double working cylinder (32).

The present invention relates to a heave compensated crane comprising a lower vertical beam and an upper vertical beam which are mutually connected via an articulated piece, as the vertical beam is connected, at the bottom, to a base which in turn comprises a slew ring for rotation of the crane about a vertical axis, and a strut is arranged between the base and the articulated piece at a distance from the vertical beam and largely in parallel with this in a normal position for the crane, and that the vertical beam is driven by, at least, one cylinder and the upper crane beam in its movement in relation to the lower beam is driven by an intermediate cylinder arrangement.

From prior art reference is made to NO 151757 which describes a device for compensation and distance variations between a suspended item from a floating carrier and the ocean bed. In more detail the document shows a device in the form of a piston and cylinder arrangement that is suspended in a cable that runs from a tower or a crane and down to a load that hangs at the end of the cable, to reduce the heave of the load that is to be placed on the ocean bottom.

Furthermore, EP 1433922 shows a hoisting apparatus in the form of cables and blocks fastened to a mast, and where a pneumatic or hydraulic cylinder is used to dampen movements of the vessel onto which the apparatus is mounted.

DE 3433104 relates to a hydraulic control mechanism for load estimations.

Common for the described documents is that they relate to heave compensation with the use of a winch and a compensator system, where the compensator system either regulates the winch or the compensator system is arranged between the winch and the load.

The compensator systems that appear in the documents can comprise both passive and active cylinders, and also single working and double working cylinders.

Also known are heave compensating systems that are placed on the deck of a vessel and which are used in combination with existing deck winches. The cable runs from the winch and via guiding discs on the deck and to the crane. A movement detector system registers heave and compensates with the help of a cylinder arrangement.

A problem that shall be solved in relation to the above mentioned technique can then be regarded to be “how to achieve heave compensation without the use of a winch system?” According to the present invention this is solved by integrating the heave compensation with the “normal” hoisting cylinders of the crane so that it is not necessary with an advanced heave compensating system on the winch.

With regard to NO 151757 it shall be pointed out that it is shown clearly a device for heave compensation that is suspended in a cable. The compensation takes place between this and the load cable that is coupled to the load. With the present solution an arrangement is shown where the hydraulic cylinders lift the crane beam with a wire disc. The compensation occurs in that the cylinders hoist and lower the beam in relation to the horizontal starting position.

One consequence is that in the embodiment of NO 151757 the load will hang in the cylinders, so that these experience a tension load, in contrast to the present crane where the cylinders work with a pressure load.

Another further consequence is that the single working, passive draw, cylinder in NO 151757 must be constructed as a double working cylinder where the piston sides have no role. The active part is made up of two double working cylinders that are in contrast to the present crane where the active part lifts the load with the help of a single working cylinder, while the active lowering of the load is carried out with the help of the rod side of, for example, two other cylinders. With this arrangement the cylinders can be adapted so that there will be an equal active area for the hoisting and lowering.

The whole of the heave compensating unit in NO 151757 is superfluous and without any use as soon as the heave-compensation operation is carried out. It represents an unfavourable additional weight which is a strain on the crane it is suspended from. It is also impossible to remove it as long as the load hangs in it. It also requires supply of hydraulic pressure and/or electric power from the ship. As the device is shown in FIG. 4 in NO 151757, the lifting of the load is hindered by the device hitting the disc housing of the cable, and the lowering of the load is limited by the ocean level, and the length of the hydraulic/electrical supply from the ship. With the present crane all hydraulic cylinders can be in use with normal operation of the crane also. The single working cylinder can be used to increase the lifting capacity beyond what the crane has during the heave compensation.

Reference is also made to WO 2010/024689 A1 and U.S. Pat. No. 5,381,909 A, where the former document is related to a crane built up by the corresponding crane construction as the present crane. U.S. Pat. No. 5,381,909 A relates to a compensating system for a winch arm onboard a boat, where the arm rotates with the help of a double working cylinder in parallel with a single working cylinder. The aim of the solution in the document U.S. Pat. No. 5,381,909 A is to adjust the angle of the winch arm and thereby the stretch tension on the load carrying cable. It is a single working load cylinder for normal operation of the winch arm and a double working servo cylinder for the regulation of the angle and thereby also the movement of the outer end of the winch arm, where the cylinders are placed in parallel and connected to an accumulator. An angle sensor system is used to provide inputs to the regulation of the angle.

Consequently, it is an object of the present invention to provide a crane where the above mentioned disadvantages are avoided, or at least reduced.

Another object of the invention is to provide a crane with a considerably improved working area for the crane.

The above mentioned problems and objects are solved by a heave compensating crane as given in the independent claim 1, in that the cylinder arrangement comprises, at least, one single working cylinder and, at least, one double working cylinder.

Alternative embodiments are given in the dependent claims 2-9.

During heave compensation the single working cylinder can be arranged to lift the crane beam and, at least, the one double working cylinder can be arranged for the lowering of the crane beam by the use of the rod side of the double working cylinder.

The cylinder arrangement can comprise a centrally placed single working cylinder and two side mounted double working cylinders, where the double working cylinders are connected to a respective accumulator. Said accumulators and any associated gas reservoir can be integrated with respective cylinders.

During normal operation the connection between the double working cylinders to said accumulators is preferably closed by a respective closing valve, whereby the whole of the cylinder arrangement is arranged for operation of the crane beam. Furthermore, during normal operation the piston side of all the cylinders can be pressurised in the normal way.

During heave compensated operation the connection between the double working cylinders to said accumulators is preferably open, as a respective closing valve is open and a respective closing valve between the double working cylinders and the hydraulic control valve is shut.

Furthermore, during heave compensated operation the piston side of the single working cylinder can be pressurised in the normal way, and the piston side of the double working cylinders can be passive, while the rod side is active. The rod side of the double working cylinders can be connected via a pipe.

The invention shall now be described in more detail with reference to the enclosed figures, in which:

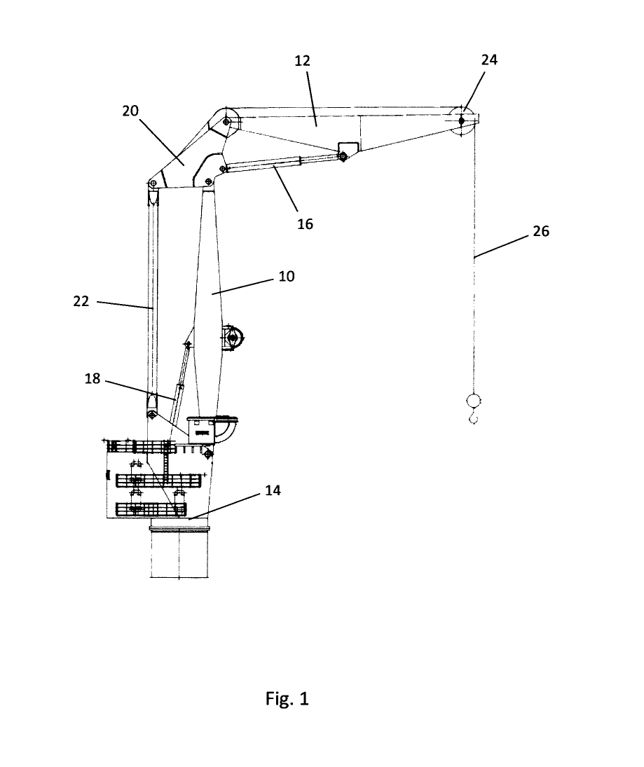

FIG. 1 shows a heave compensated crane according to the invention.

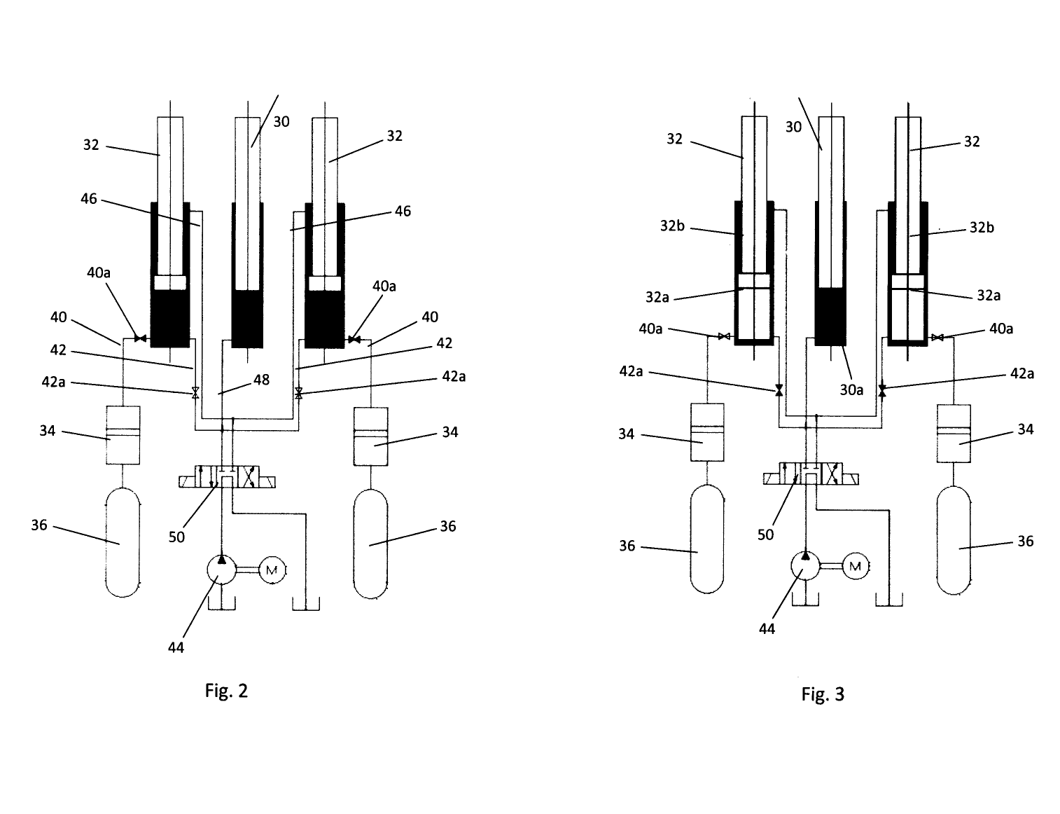

FIG. 2 shows a cylinder arrangement for the crane during normal operation.

FIG. 3 shows a cylinder arrangement for the crane during heave compensated operation.

FIG. 1 shows the crane according to the invention. It is possible to use, for example, the crane described in the Norwegian patent application NO 20083654.

An aim of the crane construction is that the crane point will be held at largely the same horizontal level during the whole of the crane operating range, due to the design of the crane.

As shown, the crane comprises two main parts, a vertical beam 10 and a horizontal beam 12. The vertical beam 10 is mounted at the bottom in a “king” or base part 14 that can rotate about a vertical axis on a bearing on the top of a bottom base. The vertical beam 10 can be moved with the help of, at least, one cylinder 18 which is mounted between a point on the base 14 and a point on the vertical beam 10. At the top end of the vertical beam 10 an articulated piece 20 is mounted. The articulated piece 20 can be, seen from the side, shaped with a “triangular” construction. The horizontal beam 12 is mounted in the articulated piece 20.

The articulated piece is held up and controlled with the help of a strut 22 which, at its lower end, is mounted in the base or the foundation 14 and, at its upper end, in the articulated piece 20.

The crane can rotate with the help of a slew ring on a pedestal as normal.

The horizontal beam 12 is held up with the help of a cylinder arrangement 16 mounted between the articulated piece and the horizontal beam 12. A wire disc 24 is fastened at the outer end of the horizontal beam 12. This guides a wire 26 from a winch mounted onto, or outside, the crane itself.

The crane moves between the largest and the smallest radius (reach) in that the vertical beam 10 is moved forwards and backwards in relation to the vertical starting position with the help of the cylinder(s) 18. During this movement the vertical beam 10 has, as its main task, regulation of the work radius of the crane. The horizontal beam 12 will compensate for the height difference that arises during this movement, so that the wire disc 24 is held at a constant height. This occurs without the cylinder arrangement 16 having to be moved and consequently the horizontal beam 12 will follow the movement of the articulated piece 20. It is the strut 22 that controls this movement. By estimating optimal mutual placing of components and connecting points, a compensation that leads to an approximately constant (horizontal) height of the wire disc 24 is achieved. It is possible to achieve a height variation of only a few percent of the radial movement.

In connection with operations offshore, for example, when the crane is mounted on a vessel, the movement of the vessel will influence the movement of the horizontal crane beam 12 and consequently also the movement of the wire disc 24. The present crane is therefore equipped with a cylinder arrangement 16 with heave compensation and which will be described in more detail in the following.

FIG. 2 shows a cylinder arrangement 16 during normal operation, while FIG. 3 shows a cylinder arrangement during heave compensated operation. As can be seen in the figures the embodiment example of the cylinder arrangement shown comprises a centrally placed, single working cylinder 30 (which can also be a double working cylinder) connected to a hydraulic control valve 50 and associated pump/motor 44 via a pipe 48. At the side of the single working cylinder 16, a double working cylinder 32 (only one double working cylinder may be used) is placed, which is connected at its piston side 32a to the same hydraulic control valve 50 via a pipe 42. A closing valve 42a is connected to the pipe 42. At the piston side 32a of the double working cylinders 32 a pipe 40 is connected with a closing valve 40a, and which leads to an accumulator 34 which in turn is connected to a gas container 36 or reservoir. A pipe 46 can run between the rod side 32b of the double working cylinders 32.

For normal lifting operation the piston side 32a of the two double working cylinders is used, but in heave compensation they are used as passive cylinders for compensation of the load. During the active function during heave compensating, the single working cylinder 30 is used for lifting, while the rod side 32b of the two double working cylinders 32 is used for the lowering.

During normal operation the connection between the double working cylinders to said accumulators is closed by the respective closing valve 40a, so that the whole of the cylinder arrangement 16 is arranged for the operation of the crane beam 12. Furthermore, the piston side of all the cylinders 30, 32 are pressurised in the normal way.

During heave compensated operation the connection between the double working cylinders 32 to said accumulators 34 is open, as the respective closing valve 40a is open and the respective closing valve 42a between the double working cylinders 32 and the hydraulic control valve 50 is closed. This leads to that during heave compensated operation the piston side 30a of the single working cylinder 30 is pressurised in the normal way and the piston side 32a of the double working cylinders 32 is passive, while the rod side 32b is active. During heave compensated operation the rod side of the double working cylinders 32 is preferably connected via a pipe 46.

Furthermore, the piston accumulators can be considered to be mounted together with the double working cylinders so that a compact, integrated design is provided.

1. Heave compensated crane, comprising a lower vertical beam (10) and an upper horizontal beam (12) which are mutually connected via an articulated piece (20), as the vertical beam is connected at the bottom to a base (14), which in turn comprises a slew ring for rotation of the crane about a vertical axis, and a strut (22) is arranged between the base (14) and the articulated piece (20) at a distance from the vertical beam (10) and largely in parallel with this in a normal position for the crane, and that the vertical beam (10) is driven by, at least, one cylinder (18) and the upper crane beam (12) in its movement in relation to the lower beam (10) is driven by an intermediate cylinder arrangement (16),
characterised in that the cylinder arrangement (16) comprises, at least, one single working cylinder (30) and, at least, one double working cylinder (32).

2. Crane according to claim 1,
characterised in that during the heave compensation the single working cylinder (30) is arranged to lift the crane beam (12) and the, at least, one double working cylinder (32) is arranged to lower the crane beam (12) by the use of the rod side (32b) of the double working cylinder.

3. Crane according to claim 1,
characterised in that the cylinder arrangement (16) comprises a centrally placed single working cylinder (30) and two side mounted double working cylinders (32), where the double working cylinders are connected to a respective accumulator (34).

4. Crane according to claim 3,
characterised in that said accumulators (34) and any associated gas reservoir (36) are integrated with respective cylinders (30, 32).

5. Crane according to one of more of the claims 2-4,
characterised in that during normal operation the connection between the double working cylinders to said accumulators is closed by a respective closing valve (40), whereby the whole of the cylinder arrangement (16) is arranged for operation of the crane beam (12).

6. Crane according to claim 5,
characterised in that during normal operation the piston side of all cylinders (30, 32) is pressurised in the normal way.

7. Crane according to one or more of the claims 2-4,
characterised in that during heave compensated operation the connection between the double working cylinders (32) to said accumulators (34) is open, as a respective closing valve (40) is open, and that a respective closing valve (42) between the double working cylinders (32) and a hydraulic control valve (50) is closed.

8. Crane according to claim 7,
characterised in that during heave compensated operation the piston side of the single working cylinder (30) is pressurised in a normal way and the piston side of the double working cylinders (32) is passive while the rod side is active.

9. Crane according to claim 8,
characterised in that during heave compensated operation the rod side of the double working cylinders (32) is connected via a pipe (46).
